(19) United States
(12) Patent Application Publication
(10) Pub. No.: US 2008/0216967 A1
(43) Pub. Date: Sep. 11, 2008

(54) Mechanism for moving all the slats away from the head in vertical direction

(76) Inventors: Wen Ying Liang, Fuxing Shiang (TW); Sheng Ying Hsu, Fuxing Shiang (TW); Wu Chung Nien, Fuxing Shiang (TW); Chien Chih Huang, Fuxing Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/713,713

(22) Filed: Mar. 5, 2007

(51) Int. Cl. E06B 9/36

(52) U.S. Cl. 160/168.1 V

(57) ABSTRACT

A blind includes a firs control unit connected with a top rail and a second control unit connected with a bottom rail. A plurality of slats are connected with each other and connected between the top and bottom rail. The first control unit includes a first operation box and a first rod on which two cords are wrapped and connected to the top rail. The second control unit includes a second operation box and a second rod on which another two cords are wrapped. A clip is connected the top rail and includes a hook to which an operation rod is connected. The top rail together with the slats is able to be pulled a distance from the head of the blind so as to form an uncovered are between the head and the top rail by pulling the operation rod.

### FIELD OF THE INVENTION

The present invention relates to a blind and more particularly, to a mechanism for moving all the slats a distance from the head of the blind.

### BACKGROUND OF THE INVENTION

A conventional blind 70 is shown in FIG. 8 and generally includes a head 71 and a plurality of slats 72 are connected with each other by ropes 73 and the slats 72 are parallel with each other. A mechanism is received in the head 71 so as to control the slats 71. A wand and a lift cord is cooperated with the mechanism, the wand controls the angle that the slats 71 tilt so that the user can set the slats 71 at a desired angular position to allow light from outside to enter the interior of the room. The lift cord allows the user to pull all the slats 71 to overlap with each other and be positioned at the underside of the head 71. By this way, the window is not covered by the blind 70.

However, all of the conventional blinds in the market cannot provide a function that the slats are moved downward to form an uncovered area between the head and the slats. This function is useful for providing sufficient light into the interior from a higher position while people in the room are not seen from outside of the room.

The present invention intends to provide a mechanism for moving all the slats away from the head to form an uncovered area between the head and the slats.

### SUMMARY OF THE INVENTION

The present invention relates to a blind which comprises a head and a firs control unit and a second control unit are received in the space of the head respectively. The first control unit includes a first operation box and a first rod, a first cord and a second cord are wrapped on two ends of the first rod respectively. The first and second cords extend through two holes defined through the head and are connected to a top rail. A first rope has a first end fixed to the first operation box and the other end of the first rope is connected to the first rod. The second control unit includes a second operation box and a second rod, a third cord and a fourth cord are wrapped on two ends of the second rod respectively. The third and fourth cords extend through the head, the top rail, a plurality of slats and are connected to a bottom rail. The slats are overlapped with each other to form a pile and a top one slat of the pile of the slats is connected to the top rail and the bottom one slat of the pile of the slats is connected to the bottom rail. A second rope has a first end fixed to the second operation box and the other end of the second rope is connected to the second rod. A clip is mounted to the top rail and includes a hook extending from a side of the clip. The hook extends beyond a side of the top rail and defines a U-shaped space. An operation rod has an enlarged end hooked with the hook.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the blind with the mechanism of the present invention;

FIG. 2 is an exploded view to show the mechanism and the slats of the blind of the present invention;

FIG. 3 is a top view to show that the two control units are received in the head;

FIG. 4 shows that the enlarged end of the operation rod is engaged with the hook of the clip on the top rail;

FIG. 5 shows a side view to show that the enlarged end of the operation rod is engaged with the hook of the clip on the top rail;

FIG. 6 shows the top rail and the slats are pulled away from the head;

FIG. 7 shows the blind in a room and the top rail and the slats are pulled away from the head, and

FIG. 8 shows a conventional blind.

### DETAILED DESCRIPTION OF THE PREFERRED EMBODIMENT

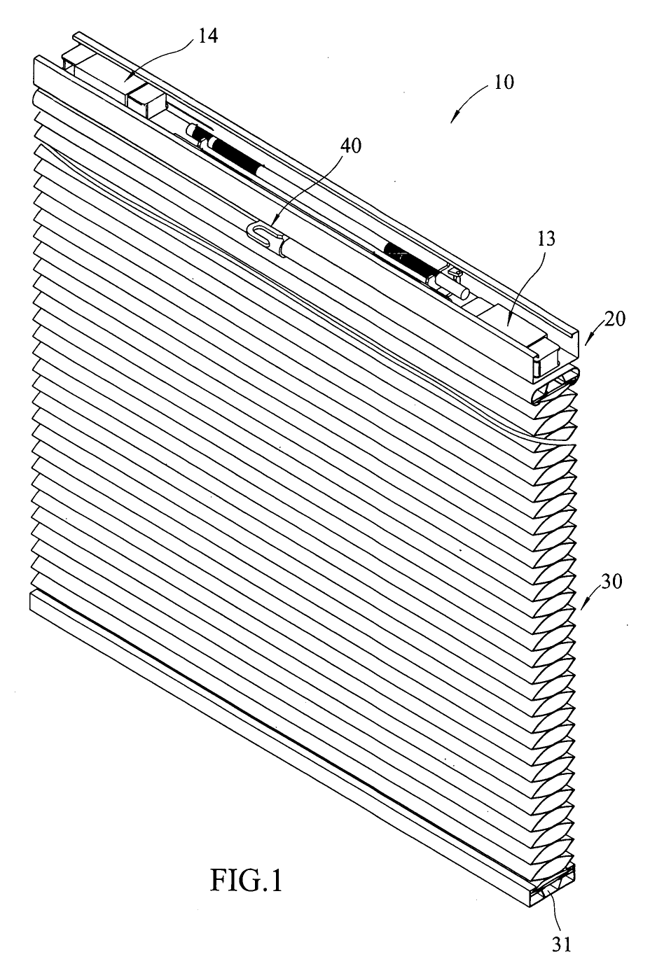

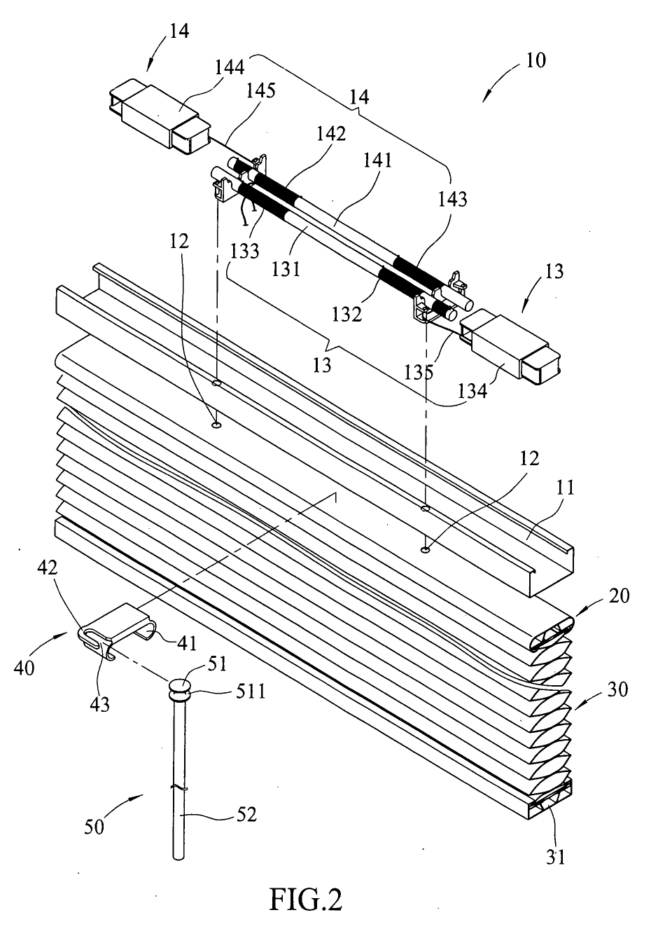

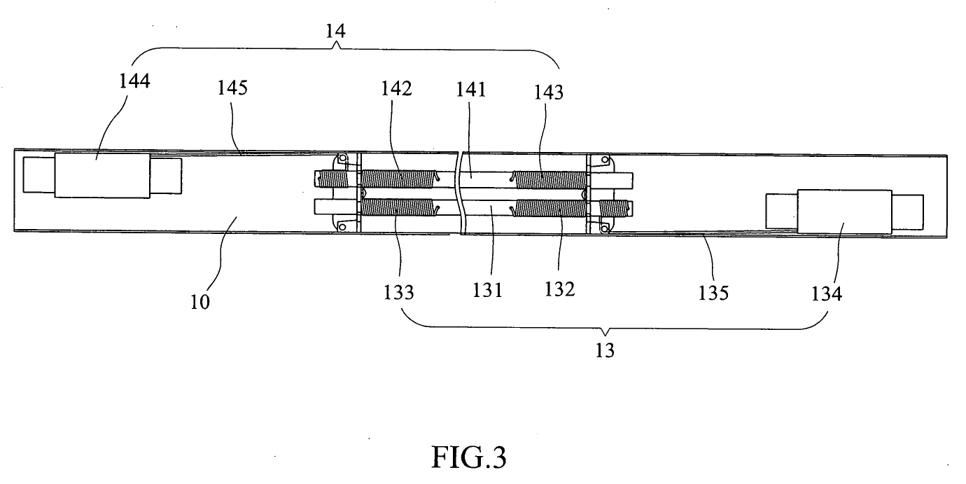

Referring to FIGS. 1 to 3, the blind 10 of the present invention comprises a head 11 having two sidewalls and a space is defined between the two sidewalls. A firs control unit 13 and a second control unit 14 are received in the space of the head 11 respectively. The first control unit 13 includes a first operation box 134 and a first rod 131. The first rod 131 is supported on two support boards in the space and a first cord 132 and a second cord 133 wrapped on two ends of the first rod 131 respectively. The first and second cords 132, 133 extend through two holes 12 defined through the head 10 and are connected to a top rail 20. A first rope 135 has a first end fixed to the first operation box 134 and the other end of the first rope 135 is connected to the first rod 131.

The second control unit 14 includes a second operation box 144 and a second rod 141 which is supported on the two support boards. A third cord 142 and a fourth cord 143 are wrapped on two ends of the second rod 141 respectively. The third and fourth cords 142, 143 extend through the head 10, the top rail 20, a plurality of slats 30 and are connected to a bottom rail 31. The slats 30 are overlapped with each other to form a pile and a top one slat 30 of the pile of the slats 30 is connected to the top rail 20 and the bottom one slat 30 of the pile of the slats 30 is connected to the bottom rail 31. Each slat 30 is an elongate tube and can be expanded to form an oval shape when viewed from either end thereof as shown in FIG. 1. A second rope 145 has a first end fixed to the second operation box 144 and the other end of the second rope 145 is connected to the second rod 141.

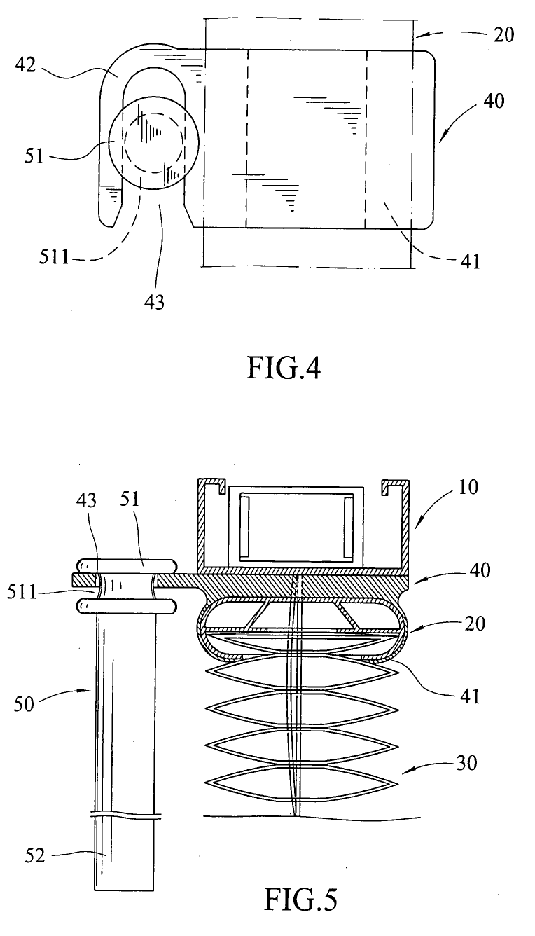

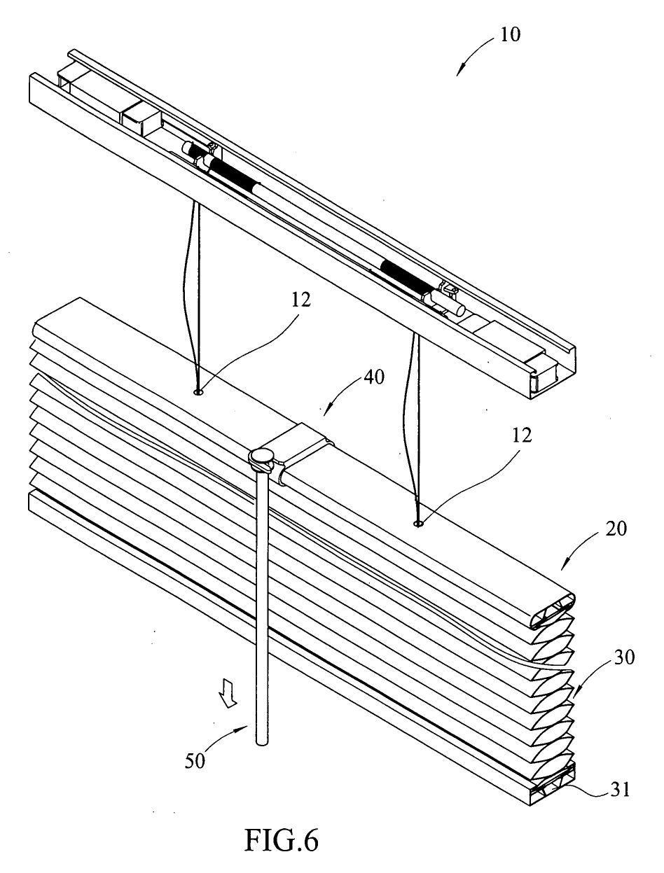

Further referring to FIGS. 4 and 5, a clip 40 has two holding portions 41 extending from an underside of two ends thereof so that the clip 40 is mounted to the top rail 20 by the holding portions 41. A hook 42 extends from a side of the clip 40 and extends beyond a side of the top rail 20 and defining a U-shaped space 43. An operation rod 50 has an enlarged end 51 and a shank 52 wherein the enlarged end 51 is connected to an end of the shank 52. The enlarged end 51 includes an annular groove 511 and an inner periphery 43 of the hook 42 is engaged with the annular groove 511.

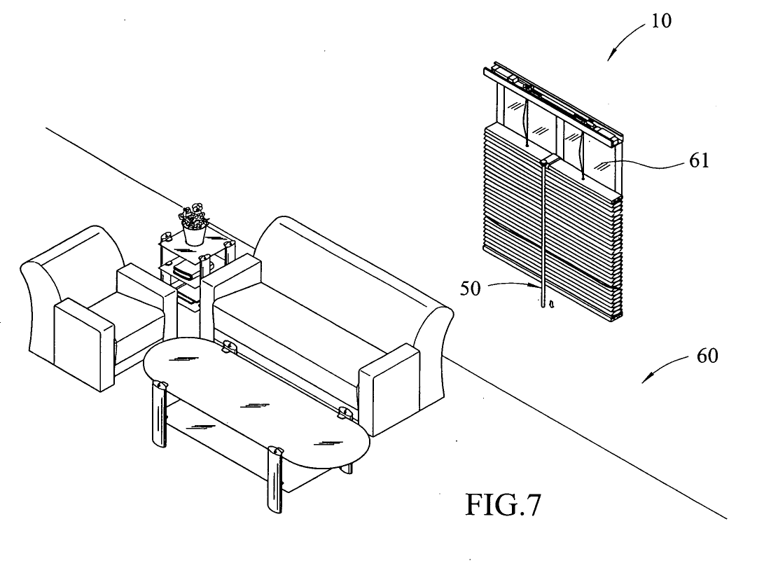

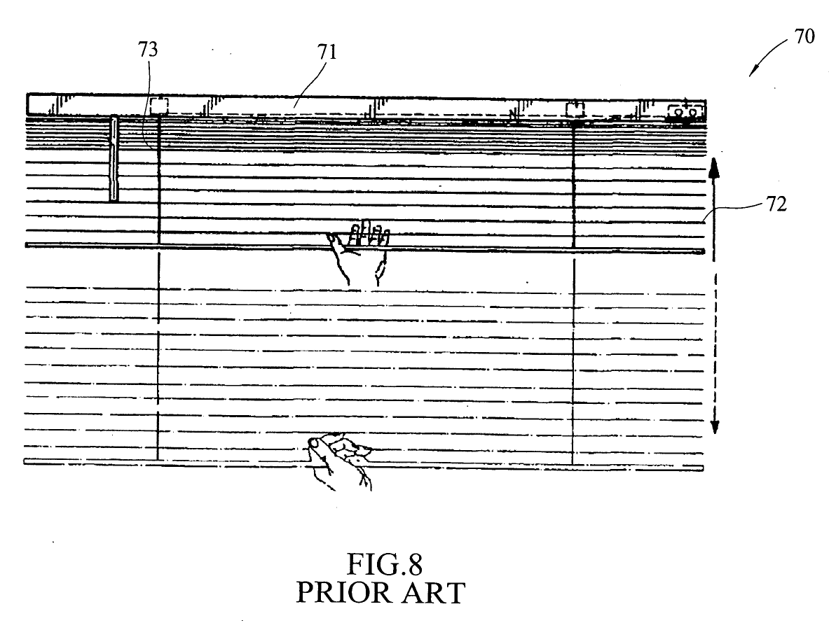

As shown in FIGS. 6 and 7, when pulling the shank 52 of the operation rod 50 downward for a proper distance, the slats 30 are pulled downward and compressed to each other by the top rail 20. The first and second cords 132, 133 of the first control unit 13 drive the first rod 131 to rotate. However, due to the user pulls the operation rod 50, the first and second cords 132, 133 are released the driving force to the first rod 131 so that the top rail 20 together with the slats 30 are pulled downward away from the head 10 so as to form a uncovered area 61 as shown in FIG. 7 such that light can be introduced into the room 60 while people outside of the room 60 cannot see the inside of the room 60 because of the slats 30.

While we have shown and described the embodiment in accordance with the present invention, it should be clear to those skilled in the art that further embodiments may be made without departing from the scope of the present invention.

What is claimed is:

1. A blind comprising:
a head having two sidewalls and a space defined between the two sidewalls;
a firs control unit received in the space of the head and including a first operation box and a first rod, the first rod supported on two support boards in the space and a first cord and a second cord wrapped on two ends of the first rod respectively, the first and second cords extending through two holes defined through the head and connected to a top rail, a first rope having a first end fixed to the first operation box and the other end of the first rope connected to the first rod;
a second control unit received in the space of the head and including a second operation box and a second rod which is supported on the two support boards, a third cord and a fourth cord wrapped on two ends of the second rod respectively, the third and fourth cords extending through the head, the top rail, a plurality of slats and being connected to a bottom rail, the slats being overlapped with each other to form a pile and a top one slat of the pile of the slats connected to the top rail and the bottom one slat of the pile of the slats connected to the bottom rail, a second rope having a first end fixed to the second operation box and the other end of the second rope connected to the second rod, and
a clip mounted to the top rail and including a hook extending from a side of the clip, the hook extending beyond a side of the top rail and defining a U-shaped space, an operation rod having an enlarged end hooked with the hook.

2. The blind as claimed in claim 1, wherein the enlarged end includes an annular groove and an inner periphery of the hook is engaged with the annular groove.

3. The blind as claimed in claim 1, wherein the operation rod includes a shank and the enlarged end is connected to an end of the shank.
